(19) United States
(12) Patent Application Publication
(10) Pub. No.: US 2023/0393545 A1
(43) Pub. Date: Dec. 7, 2023

(54) CONTEXT-AWARE BUILDING AUTOMATION SYSTEMS

(71) Applicant: Siemens Schweiz AG, Zurich (CH)

(72) Inventors: Uma Dattaraj Sinai Sadekar, Pashan (IN); Karan Dhadge, Pune (IN); Manmeet Singh Gandhi, Nagpur (IN)

(21) Appl. No.: 17/829,458

(22) Filed: Jun. 1, 2022

(51) Int. Cl. G05B 19/042

(52) U.S. Cl. CPC G05B 19/042; G05B 2219/25011

(57) ABSTRACT

A context-aware building automation system and a method for enabling the same is disclosed herein. The method comprises detecting, by a processing unit, an event associated with an occupant of a building based on a request received from one or more sources. Further, occupant-context data associated with the occupant is obtained, from an identity graph of the occupant, upon detecting the event. The occupant-context data is used to dynamically determine at least one action to be performed at one or more target devices in the building. The at least one action customizes functioning of the one or more target devices for the occupant. Further, one or more instructions are transmitted to the one or more target devices, for performing the at least one action determined.

### FIELD OF TECHNOLOGY

The present disclosure relates to building automation systems, and more particularly relates to a context-aware building automation system.

### BACKGROUND

Building automation systems, also known as building automation systems, monitor and control various electrical and mechanical devices within a building. The devices may be associated with different functions including, but not limited to, ventilation, lighting, power systems, fire systems, and security systems. The various devices are controlled based on data gathered from a plurality of sensors.

In existing art, functioning of building automation systems is not dependent on contextual data pertaining to occupants of the building. In particular, current building automation systems utilize human occupancy data to determine only the presence of human occupants in a specific area within the building for decision making. Apart from occupancy, other contextual information associated with the occupant, such as preferences or special needs, is not considered by the building automation system for performing functions related to ensuring safety and/or comfort of the occupants.

In light of the above, there exists a need for a building automation system that considers contextual information related to a building occupant for customising actions performed by automation devices in the building, in a manner suited to the occupant.

### SUMMARY

In an aspect of the present disclosure, a method for enabling a context-aware building automation system is disclosed. The method comprises detecting, by a processing unit, an event associated with an occupant of a building based on a request received from one or more sources. The method further comprises obtaining occupant-context data associated with the occupant, from an identity graph of the occupant, upon detecting the event. In an embodiment, the identity graph of the occupant is generated based on personal data of the occupant received from the one or more sources. The personal data comprises at least one of personally identifiable information and non-personally identifiable information. In a further embodiment, the identity graph may be uniquely identified using a persistent identifier generated by hashing at least one personally identifiable information of the occupant. In an embodiment, the occupant-context data comprises identifiers indicative of one or more of physiological data, demographic data, physiographic data, preferences, physical attributes and real-time location of the occupant. In an embodiment, the step of obtaining the occupant-context data associated with the occupant from the identity graph comprises: authenticating a personally identifiable information of the occupant, obtained in relation to the event; identifying the identity graph of the occupant from a database, based on a persistent identifier computed from the personally identifiable information; and querying the identity graph of the occupant to retrieve the occupant-context data.

The method further comprises dynamically determining, by the processing unit, at least one action to be performed at one or more target devices in the building based on the occupant-context data. The at least one action customizes functioning of the one or more target devices for the occupant. In an embodiment, dynamically determining, by the processing unit, the at least one action to be performed at the one or more target devices in the building based on the occupant-context data, comprises determining a customized configuration for the one or more target devices based on the occupant-context data; and generating the one or more instructions for modifying a setting of the one or more target devices for effecting the customized configuration. The method further comprises transmitting one or more instructions to the one or more target devices, for performing the at least one action determined.

In an embodiment, the identity graph is dynamically updatable based on updated personal data of the occupant received from the one or more sources in real-time. In an embodiment, dynamically updating the identity graph based on the updated personal data of the occupant comprises: identifying a class of the updated personal data based on the source; determining whether at least one node of the identity graph corresponds to the class of the updated personal data; if at least one node of the identity graph corresponds to the class of the updated personal data, updating the node based on the updated personal data; and if no node of the identity graph corresponds to the class of the updated personal data, creating a new node based on the updated personal data.

In another aspect of the present disclosure, a context-aware building automation system is disclosed. The building automation system comprises one or more sources, one or more target devices, and an apparatus communicatively coupled to the one or more sources and the one or more target devices. The apparatus is configured to detect an event associated with an occupant of a building based on a request received from the one or more sources. The apparatus is further configured to obtain occupant-context data associated with the occupant, from an identity graph of the occupant, upon detecting the event. In an embodiment, the identity graph of the occupant is generated based on personal data of the occupant received from the one or more sources. The personal data comprises at least one of personally identifiable information and non-personally identifiable information. In a further embodiment, the identity graph is uniquely identified using a persistent identifier generated by hashing at least one personally identifiable information of the occupant.

In an embodiment, the occupant-context data comprises identifiers indicative of one or more of physiological data, demographic data, physiographic data, preferences, physical attributes and real-time location of the occupant. In an embodiment, the apparatus obtains the occupant-context data associated with the occupant from the identity graph of the occupant by authenticating a personally identifiable information of the occupant, obtained in relation to the event; identifying the identity graph of the occupant from a database, based on a persistent identifier computed from the personally identifiable information; and querying the identity graph of the occupant to retrieve the occupant-context data.

The apparatus is further configured to use the occupant-context data to dynamically determine at least one action to be performed at one or more target devices in the building, wherein the at least one action customizes functioning of the one or more target devices for the occupant. In an embodiment, the apparatus dynamically determines the at least one action to be performed at the one or more target devices in the building based on the occupant-context data by determining a customized configuration for the one or more target devices based on the occupant-context data; and generating the one or more instructions for modifying a setting of the one or more target devices for effecting the customized configuration. The apparatus is further configured to transmit the one or more instructions to the one or more target devices, for performing the at least one action determined.

In an embodiment, the apparatus is further configured to dynamically update the identity graph based on updated personal data of the occupant received from the one or more sources in real-time. In a further embodiment, the apparatus dynamically updates the identity graph in real-time based on the updated personal data of the occupant by identifying a class of the updated personal data based on the source; determining whether at least one node of the identity graph corresponds to the class of the updated personal data; if at least one node of the identity graph corresponds to the class of the updated personal data, updating the node based on the updated personal data; and if no node of the identity graph corresponds to the class of the updated personal data, creating a new node based on the updated personal data.

The object of the present invention is also achieved by a computer-readable medium, on which program code sections of a computer program are saved, the program code sections being loadable into and/or executable by a processor which performs the method as described above when the program code sections are executed. The realization of the invention by a computer program product and/or a non-transitory computer-readable storage medium has the advantage that computer systems can be easily adopted by installing computer program in order to work as proposed by the present disclosure. The computer program product can be, for example, a computer program or comprise another element apart from the computer program. This other element can be hardware, for example a memory device, on which the computer program is stored, a hardware key for using the computer program and the like, and/or software, for example a documentation or a software key for using the computer program.

### BRIEF DESCRIPTION

The above-mentioned attributes, features, and advantages of the present invention and the manner of achieving them, will become more apparent and understandable (clear) with the following description of embodiments of the invention in conjunction with the corresponding drawings. The illustrated embodiments are intended to illustrate, but not limit the invention.

The present invention is further described hereinafter with reference to illustrated embodiments shown in the accompanying drawings, in which:

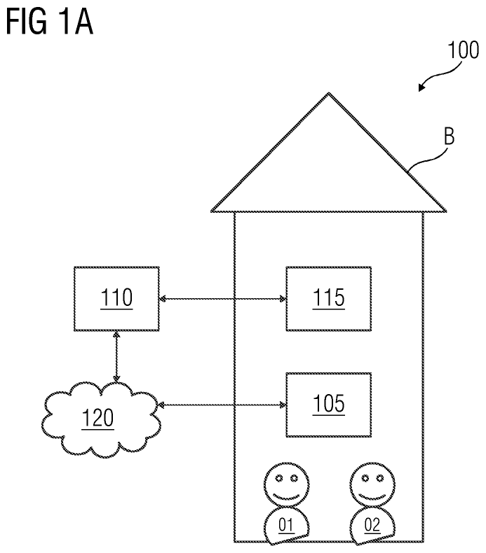

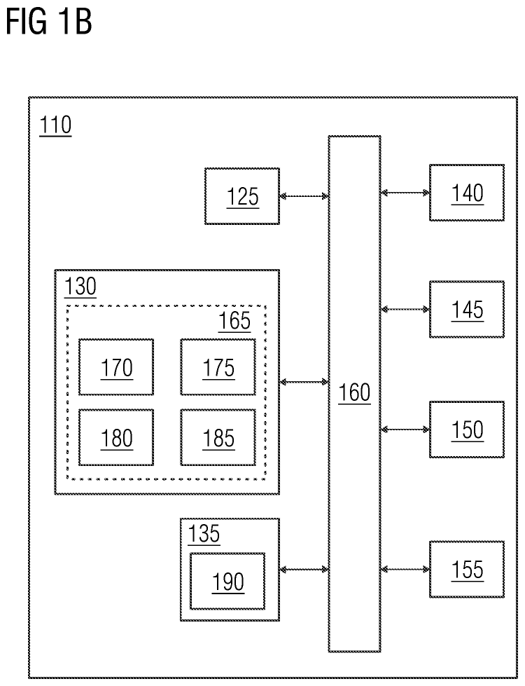

FIG. 1A illustrates a block diagram of a building automation system, in accordance with an embodiment of the present disclosure;

FIG. 1B illustrates an apparatus for customizing function of target device based occupancy-context data, in accordance with an embodiment of the present disclosure;

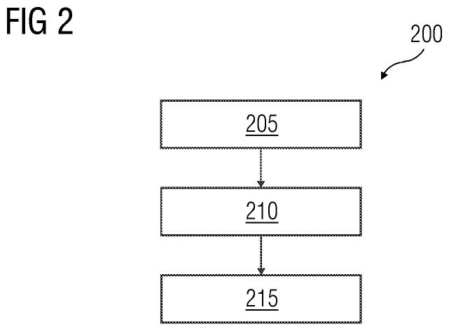

FIG. 2 shows a flowchart of an exemplary method for generating identity graphs for one or more occupants of a building, in accordance with an embodiment of the present disclosure;

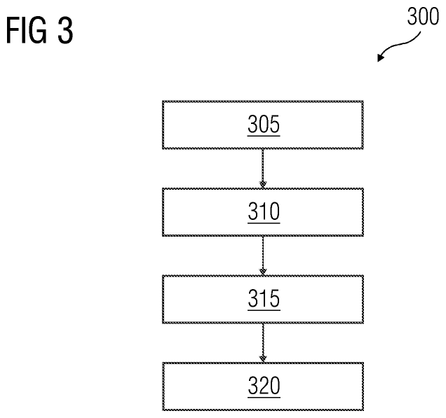

FIG. 3 shows a flowchart of a method for updating an identity graph, in accordance with an embodiment of the present disclosure;

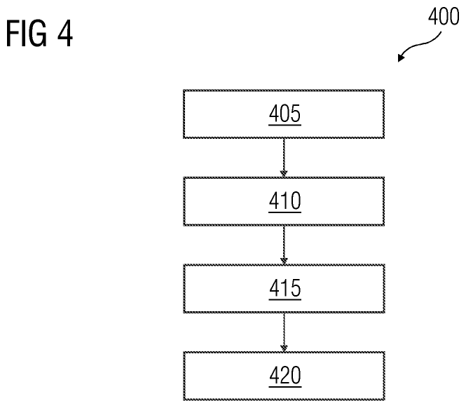

FIG. 4 shows a flowchart of an exemplary method for customizing functioning of one or more target devices associated with a building, in accordance with an embodiment of the present disclosure;

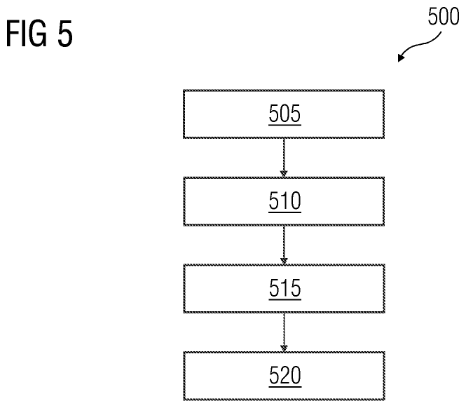

FIG. 5 shows a flowchart of an exemplary method for providing assistance to occupants of a building in emergency situations, in accordance with an embodiment of the present disclosure; and

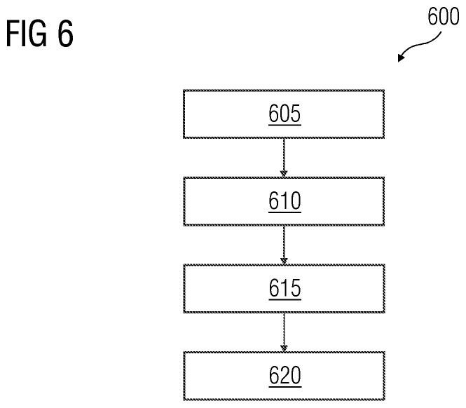

FIG. 6 shows a flowchart of an exemplary method for customizing room settings for a guest at a hotel, in accordance with an embodiment of the present disclosure.

### DETAILED DESCRIPTION

Hereinafter, embodiments for carrying out the present disclosure are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

FIG. 1A illustrates a block diagram of a context-aware building automation system 100, in accordance with an embodiment of the present disclosure. The system 100 comprises one or more sources 105 communicatively coupled to an apparatus 110. The system 100 further comprises one or more target devices 115 communicatively coupled to the apparatus 110. In an example, both the one or more sources 105 and the one or more target devices 115 may be housed in a building B housing two occupants O1 and O2.

The term “source” as used herein may refer to any hardware device or software entity configured to supply personal data associated with the occupant to the apparatus 110. Non-limiting examples of the one or more sources 105 may include personal electronic devices associated with an occupant, IoT devices, web-based or client-based applications, wearable devices, sensors etc. Herein, personal data includes Personally Identifiable Information (PII) and Non-Personally Identifiable Information (NPII). Each piece of the PII and the NPII may be generated by the one or more sources 105, as an identifier or a digital token associated with the occupant. Many such identifiers may be generated by an occupant based on his/her interactions with specific devices or applications. PII may include attributes that may uniquely identify the occupant. Non-limiting examples of PII may include email address, national identification numbers, employee identification numbers, browser cookies, and device identification numbers associated with the occupant. Herein, the device identification numbers may correspond to the one or more sources 105 providing the personal data of the occupant or a personal electronic device of the occupant.

NPII may include, but are not limited to, demographic data, physiological data, physiographic data, and real-time location of an occupant. Examples of demographic data may include age, gender, etc. Such demographic data may be obtained, via Application Programming Interfaces, from a web-based or client-based application comprising a user profile of the occupant. Non-limiting examples of physiological data includes blood pressure, blood sugar levels, heart rate, body temperature, pulse rate, respiration rate, blood volume, sound pressure, photoplethysmography, electroencephalogram, electrocardiogram, blood oxygen saturation, and skin conductance. The physiological data may be obtained from wearable devices, sensors or from health monitoring applications. Non-limiting examples of physiographic data may include emotional state, physical status (e.g., asleep or awake) and preferences. In an embodiment, the personal electronic device may comprise one or more applications that may be used by the occupant to log special needs or to set preferences with respect to the building automation system.

The one or more target devices 115 may include, but are not limited to, client devices, display devices, electric appliances, consumer electronics, embedded systems, heating systems, lighting systems, ventilation systems, air-conditioning systems and access control systems. Each of the one or more sources 105 and the one or more target devices 115 are connected to the apparatus 110 via a network 120, for example, local area network (LAN), wide area network (WAN), Wi-Fi, etc. In one embodiment, the apparatus 110 is deployed in a cloud computing environment.

As used herein, “cloud computing environment” refers to a processing environment comprising configurable computing physical and logical resources, for example, networks, hardware, storage, applications, services, etc., and data distributed over the network, for example, the internet. The cloud computing environment provides on-demand network access to a shared pool of the configurable computing physical and logical resources.

The apparatus 110 comprises a processing unit 125, a memory 130, a storage unit 135, a communication unit 140, a network interface 145, an input unit 150, an output unit 155, a standard interface or bus 160. The apparatus 110 can be a (personal) computer, a workstation, a virtual machine running on host hardware, a microcontroller, or an integrated circuit. As an alternative, the apparatus 110 can be a real or a virtual group of computers (the technical term for a real group of computers is “cluster”, the technical term for a virtual group of computers is “cloud”).

The term ‘processing unit’, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processing unit 125 may also include embedded controllers, such as generic or programmable logic devices or arrays, application specific integrated circuits, single-chip computers, and the like. In general, the processing unit 125 may comprise hardware elements and software elements. The processing unit 125 can be configured for multithreading, i.e. the processing unit 125 may host different calculation processes at the same time, executing the either in parallel or switching between active and passive calculation processes.

The memory 130 may include one or more of a volatile memory and a non-volatile memory. The memory 130 may be coupled for communication with the processing unit. The processing unit 125 may execute instructions and/or code stored in the memory 130. A variety of computer-readable storage media may be stored in and accessed from the memory 130. The memory 130 may include any suitable elements for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like.

The memory 130 comprises a building management unit 165. The building management unit 165 further comprises an event detection unit 170, an identity graph unit 175, a customization unit 180 and an instruction management unit 185. The event detection unit 170 is configured to detect event associated with an occupant of a building based on an input from the one or more sources 105. The identity graph unit 175 is configured to generate and update identity graphs for occupants of a building, based on information received from sources. The identity graph unit 175 is also configured to obtain occupant-context data associated with an occupant of the building, from an identity graph of the occupant. The customization unit 180 is configured to dynamically determine at least one action to be performed at the one or more target devices 115 based on the occupant-context data. The at least one action customizes functioning of the one or more target devices 115 for the occupant. The instruction management unit 185 is configured to generate and transmit one or more instructions to the one or more target devices 115, for performing the at least one action determined.

The building management unit 165 may be stored in the memory 130 in the form of machine-readable instructions and executable by the processing unit 125. These machine-readable instructions when executed by the processing unit 125 causes the processing unit 125 to manage functions of the one or more target devices 115 based on the identity graph of the occupant.

The storage unit 135 comprises a non-volatile memory which stores information associated with the occupants. In an embodiment, the storage unit 135 may include one or more databases. The apparatus 110 may include a database 190 that stores client data associated with each of the one or more sources 105, and graph database that stores identity graph data associated with a plurality of occupants.

The network interface 145 enables the apparatus 110 to communicate with the one or more sources 105 and the one or more target devices 115 via the network 120. The input unit 150 may include input means such as keypad, touch-sensitive display, camera, etc. capable of receiving input signal. The bus acts as interconnect between the processing unit 125, the memory 130, the storage unit 135, and the network interface 145. The output unit 155 may include display devices, audio output devices, sound cards, video cards etc.

The communication unit 140 enables the apparatus 110 to communicate with the one or more sources 105 and the one or more target devices 115. The communication unit 140 may support different standard communication protocols such as Transport Control Protocol/Internet Protocol (TCP/IP), Profinet, Profibus, Internet Protocol Version (IPv), AMQP, Bluetooth and BLE, Cellular, CoAP, DDS, LoRa and LoRaWAN, LWM2M, MQTT, Wi-Fi, XMPP, Zigbee and Z-Wave.

Those of ordinary skilled in the art will appreciate that the hardware depicted in FIGS. 1A & 1B may vary for different implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter, network connectivity devices also may be used in addition or in place of the hardware depicted. The depicted example is provided for the purpose of explanation only and is not meant to imply architectural limitations with respect to the present disclosure.

The present disclosure is not limited to a particular computer system platform, processing unit, operating system, or network. One or more aspects of the present disclosure may be distributed among one or more computer systems, for example, servers configured to provide one or more services to one or more client computers, or to perform a complete task in a distributed system. For example, one or more aspects of the present disclosure may be performed on a client-server system that comprises components distributed among one or more server systems that perform multiple functions according to various embodiments. These components comprise, for example, executable, intermediate, or interpreted code, which communicate over a network using a communication protocol. The present disclosure is not limited to be executable on any particular system or group of system, and is not limited to any particular distributed architecture, network, or communication protocol.

FIG. 2 shows a flowchart of an exemplary method 200 for generating identity graphs for one or more occupants of a building, in accordance with an embodiment of the present disclosure. The method comprises steps 205 to 215 that are executable as machine-readable instructions on the apparatus 110.

At step 205, one or more personal data associated with an occupant is received from at least one source. The personal data may comprise PII and/or NPII associated with the occupant. In an example, the building may be a hotel and the at least one source may be a mobile application associated with making reservations in the hotel. The occupant may create a profile on the mobile application by providing basic information such as name, phone number, email address and age. Here, phone number and email address are considered PII as they are unique to an individual, whereas name and age are non-PII. In another example, the personal data are received from a plurality of sources. For example, Application Programming Interfaces associated with a plurality of mobile applications may provide the personal data associated with the occupant.

In another example, the building may be a hospital with the occupants being patients and hospital staff. For each of the patients, personal data are obtained from sources including, but not limited to, clinical information systems, wearable devices worn by the patients and mobile devices carried by the patient. For example, once the patient enters premises of the hospital, he or she may check in at a check-in kiosk by providing information such as name, age, gender, mobile number, email address etc. Further, the patient may also provide details of his/her treatment history. For example, the treatment history may be specified using terms such as diabetic, hypertension, arrythmia, unstable angina, leukemia etc. In an embodiment, the patient or a bystander of the patient may enter the above-mentioned details directly via a check-in device provided at the check-in kiosk. In another embodiment, the user may have a client application pre-installed on his or her mobile device. The patient or the bystander may use the client application to enter the above-mentioned details in advance. Further to the above, the client application may be also configured to access physiological data from the wearable device of the patient via Application Programming Interfaces. Similarly, personal data associated with the hospital staff may be based on information, including but not limited to, name, age, gender, qualifications, work timings and real-time location of the hospital staff.

At step 210, each of the personal data associated with an occupant is mapped to a known digital identifier. In other words, the information received from the one or more sources 105 is ‘fused’ or converted into a structured format. In the present example, the personal data “phone number” may be mapped to a known digital identifier “contact number”. Based on the mapping to the known digital identifiers, the identity graph of the occupant is generated. The generated identity graph is stored in a graph database such as, for example, Neo4j. The graph database provides a unified representation of personal data pertaining to the occupant to form a unified occupant profile.

In the identity graph, relationships between two known digital identifiers is considered as the relationship between corresponding personal data received from the sources. For example, if two classes or types of personal data ‘Customer name’ and ‘condition’ are related as ‘Customer name’ is diagnosed with ‘condition’, the relationship is ‘is diagnosed with’. Each identity graph is associated with a persistent identifier. The persistent identifier is a long-lasting reference to the identity graph, that may serve as a unique reference to the identity graph.

At step 215, the persistent identifier is generated by encrypting a PII such as contact number or email address using a hash key. Advantageously, the use of encrypted or hashed PII as persistent identifier of the identity graph ensures that the confidentiality of PII is not compromised. However, it must be understood by a person skilled in the art that the persistent identifier may be generated by hashing one or more of PII, NPII or a combination thereof. The persistent identifiers may be further stored in as a node of the identity graph. During a subsequent entry or visit of the occupant to the building, the persistent identifier may be used to access the identity graph of the occupant.

FIG. 3 shows a flowchart of a method 300 for updating an identity graph, in accordance with an embodiment of the present disclosure. The identity graph is updated dynamically or over regular intervals of time based on a rate at which the one or more sources 105 transmit updated information (i.e. updated personal data) to the apparatus 110. The method 300 comprises steps 305 to 320, executable as machine-readable instructions on the apparatus 110.

At step 305, a class of the updated personal data is identified based on the source. In the example of hospitals, if the updated personal data is received from a wearable device, then the class of personal data may be ‘wearable device’. In another example, if the updated personal data is from a clinical information system, the class of personal data may be clinical information system.

At step 310, it is determined whether at least one node of the identity graph corresponds to the class of the updated personal data. If yes, step 315 is performed. Otherwise, step 320 is performed.

At step 315, a node corresponding to the class of the personal data is updated based on the updated information. More specifically, one or more digital identifiers corresponding to the node are updated based on new values received from the source.

At step 320, a new node is created based on the updated information. The new node is associated with one or more digital identifiers indicative of the updated information.

FIG. 4 shows a flowchart of an exemplary method 400 for customizing functioning of one or more target devices (similar to the one or more target devices 115) associated with a building, in accordance with an embodiment of the present disclosure. The method comprises steps 405 to 420. Herein, the example of a hospital building comprising patients and hospital staff as occupants is considered primarily for describing the method.

In the present embodiment, identity graphs associated with occupants, (i.e., patients and hospital staff) are used to configure functionalities of one or more target devices associated with the hospital. The identity graphs are generated for each of the patients based on personal data obtained from sources including, but not limited to, clinical information systems, wearable devices worn by the patients and mobile devices carried by the patient. For example, once the patient enters premises of the hospital, he or she may check in at a check-in kiosk by providing information such as name, age, gender, mobile number, email address etc. Further, the patient may also provide details of his/her treatment history. For example, the treatment history may be specified using terms such as diabetic, hypertension, arrythmia, unstable angina, leukemia etc. In an embodiment, the patient or a bystander of the patient may enter the above-mentioned details directly via a check-in device provided at the check-in kiosk. In another embodiment, the user may have a client application pre-installed on his or her mobile device. The patient or the bystander may use the client application to enter the above-mentioned details in advance. Further to the above, the client application may be also configured to access physiological data from the wearable device of the patient to the apparatus via Application Programming Interfaces.

Similarly, identity graphs for the hospital staff are also generated based on information, including but not limited to, name, age, gender, qualifications, work timings, real-time location etc. of the hospital staff. Further, the identity graph of the occupant is automatically generated at the apparatus based on the personal data received as explained earlier with reference to FIG. 2. The identity graph is stored in a graph database that provides a unified representation of personal data pertaining to an occupant to form a unified occupant profile.

At step 405, an event associated with an occupant of a building is detected, based on a request received from one or more sources (similar to the one or more sources 105). Upon detecting the event, the source may generate a request for customizing function of one or more target devices. The request may be generated by the source upon detecting presence of the occupant within the building. For example, the source may be an access system. The occupant may provide at least one of his/her PII, i.e. a unique identification number, to the access system in order to gain access to the building. The unique identification number may be provided using an RFID-based system. In another example, the presence of the occupant is detected using face-recognition. In case of hospitals, if the patient is not a first-time visitor of the hospital, he/she may enter on the check-in device, personal data such as mobile number, email address or a unique identification number. In case the patient is a first-time visitor, then an identity graph is generated as explained earlier using FIG. 2. Further, the source transmits the request along with the personal data corresponding to the occupant, to an apparatus (similar to apparatus 110).

At step 410, occupant-context data associated with the occupant of the building are obtained from an identity graph of the occupant. In order to obtain the occupant-context data, firstly, the PII associated with the occupant, as received with the request from the source, is authenticated. In an embodiment, authenticating the PII includes using the PII to determine a persistent identifier associated with the identity graph of the specific occupant. More specifically, the PII is firstly hashed, and the hashed PII is further compared with a plurality of persistent identifiers present in a look-up table storing metadata corresponding to identity graphs associated with past or current occupants of the building. Further, a persistent identifier matching the hashed PII is identified from the look-up table.

Using the identified persistent identifier, the identity graph of the occupant is selected from a plurality of identity graphs stored in a graph database. Further, the identity graph is queried to identify occupant-context data associated with the occupant. More specifically, querying the identity returns a value (i.e., identifiers) representative of occupant-context data associated with the occupant. In an example, the occupant-context data may be associated with special needs or preferences associated with the occupant.

In an example, the occupant may have preferences with respect to room temperature, water temperature, fan speeds, lighting levels etc. For example, the identity graph may be queried to identify the room temperature preference. Upon querying, the identity graph may return a value, of say, 22 degree Celsius as room temperature preference of the occupant. Similarly, the identity graph may be also queried to identify special needs of the occupant. For example, the occupant may be elderly, handicapped or pregnant.

In the present example of hospitals, the occupant may have certain health condition. For example, the occupant may be diabetic, have low blood pressure or may be suffering from a cardiac attack. As may be understood by a person skilled in the art, the occupant-context data selected from the identity graph may vary based on functions performed by the building automation system. As may be understood, occupant-context data may vary based on scenarios, or the type of target systems involved. For example, occupant-context data for a heating system, may be different from the occupant-context data for an access control system.

At step 415, at least one action to be performed at the one or more target devices is dynamically determined based on the occupant-context data. The at least one action is associated with customizing functioning of the one or more target devices for the occupant. Further, a customized configuration of the one or more target devices is determined using the occupant-context data. Herein, the customized configuration refers to, for example, a configuration of the target device to operate or perform a function in a manner suited to the occupant.

In an embodiment, the customized configuration may be associated with adjusting functioning of heating, ventilation or lighting systems based on preferences of the occupant identified from the identity graph. For example, a room temperature preference of the occupant may be identified upon querying the identity graph of the occupant, as say 22 degree Celsius. In another embodiment, the customized configuration is associated with updating user-interface of a target device, e.g., a personal digital assistant or a display device, based on one or more identifiers associated with the occupant. In yet another embodiment, the customized configuration is associated with updating a list (e.g. an priority order) stored in a storage unit of the target device based on the one or more identifiers. Further, one or more instructions for modifying a setting of the one or more target devices for effecting the customized configuration, are generated. The one or more instructions are machine-readable instructions executable by the one or more target devices.

In the case of hospitals, the target device may be an appointment management system. For example, the apparatus may extract vital measurements such as heart rate, breathing rate, sugar levels, etc from the identity graph. If the vital measurements are above or below normal levels, then the apparatus may generate one or more instructions for the appointment management system to schedule an emergency appointment for the patient with an emergency department.

In another example, the target device is a handheld device operated by the doctor. The instructions may be associated with configuring the handheld device to generate a notification indicating the patient's details such as name, age, gender, vital measurements and treatment history. The instructions may be also associated with configuring the handheld device to generate a patient record by populating a predefined template, based on the patient's details received from the apparatus.

At step 420, the one or more instructions are transmitted to the one or more target devices, for performing the at least one action determined. The one or more instructions are transmitted to the target device, over the network based on a communication protocol associated with the target device. Non-limiting examples of communication protocols include, but are not limited to, AMQP, Bluetooth and BLE, Cellular, CoAP, DDS, LoRa and LoRaWAN, LWM2M, MQTT, Wi-Fi, XMPP, Zigbee and Z-Wave. Upon receiving the one or more instructions, the one or more target devices perform the action determined at step 415.

FIG. 5 shows a flowchart of an exemplary method 500 for providing assistance to occupants of a building in emergency situations, in accordance with an embodiment of the present disclosure. It may be appreciated that when emergency situations arise, it is necessary to priorities special needs of occupants for ensuring smooth evacuation. For example, the occupants may include elderly people, pregnant women, handicapped people etc. Therefore, identification of such occupants present in the building and prioritising their special needs is necessary. The identification of occupants present in the building may be based on an electronic check-in history or electronic attendance record.

At step 505, an emergency is detected. For example, the emergency is detected based on outputs generated by fire detectors, smoke detectors or based on actuation of a manually-operated alarm. Further, a PII of each occupants present within the building are identified. In an implementation, the PII of an occupant is identified based on an electronic check-in history or electronic attendance record. For example, when a smoke detector detects presence of fire in the building, occupants within the building or a floor of the building may be identified based on information available from access control systems or based on real-time location of the occupants provided by their respective wearable or handheld devices. Further, a persistent identifier corresponding to the PII is determined by hashing the PII.

At step 510, the persistent identifier is used to identify identity graphs associated with each of the occupants.

At step 515, respective identity graphs of each occupant is queried, for example, to determine names, real-time locations and special needs of the occupant.

At step 520, an evacuation plan is generated based on the special needs of the occupant. The evacuation plan may be generated based on predetermined rules for prioritising evacuation of occupants with special needs. For example, the evacuation plan may prioritise floors or rooms for evacuation, based on the location of the smoke detector that first generated the fire alarm, the real-time location of the occupants, and their special needs. Further, evacuation plan may also include details of equipment such as stretchers or wheelchairs to be used for evacuating the occupants with special needs. In an example, a message comprising information about the evacuation plan may be generated and transmitted to one or more target devices. The target device may be a handheld device associated with an emergency response personnel residing inside or outside the building.

FIG. 6 shows a flowchart of an exemplary method 600 for customizing room settings for a guest at a hotel, in accordance with an embodiment of the present disclosure.

At step 605, an event corresponding to check-in of the guest into the hotel is detected by a source. For example, the source may be a desktop used by a receptionist of the hotel for checking in the guest. The receptionist may log details of the guest such as name, phone number, email address, preferences etc. In addition or alternatively, the source may also include a mobile application associated with making reservations in the hotel. The guest may create a user profile on the mobile application by providing his details including PII and one or more NPIIs such as additional preferences related to, but not limited to, room temperature, water temperature, lighting, wake-up calls, laundry etc. Upon creating of the user profile, an Application Programming Interface of the mobile application transmits personal data present in the user profile to the apparatus. The apparatus further maps the personal data to corresponding digital identifiers of an identity graph for updating the identity graph. If the identity graph of the guest is pre-existing, then pre-existing digital identifiers present in the identity graph may be considered as default values, if the guest fails to update the user profile via the mobile application.

At step 610, occupant-context data associated with the guest is obtained from the identity graph, upon detecting the check-in. Here, the occupant-context data is obtained by querying the identity graph for preferences of the guest related to heating, lighting, air-conditioning, wake-up alarm, laundry etc. For example, the identity graph may be queried to identify the room temperature preference. Upon querying, the identity graph may return a value, of say, 22 degree Celsius as room temperature preference of the occupant.

At step 615, the occupant-context data is used to generate instructions for modifying settings or configuring of target devices such as heating systems, lighting systems, air-conditioning systems, etc. Further, instructions for updating the desktop computer at the front desk of the hotel based on preferences related wake-up calls, laundry etc. are also generate. For example, instructions for updating a list stored in an internal memory, or a user-interface of the desktop computer, based on the occupant-context data, may be generated.

At step 620, the instructions are transmitted to the target devices for performing the actions described in step 615.

Advantageously, the present invention enables a context-aware building automation system that considers not only building occupancy, but also contextual data associated with each occupant of the building for customizing devices within the building for the occupant. Further, the building automation system dynamically adapts to new preferences or special needs of the occupant, once the identity graph is updated by a source about the new preferences or special needs. As a result, manual efforts required in adapting the building automation system to needs of occupants, is reduced.

While the invention has been illustrated and described in detail with the help of a preferred embodiment, the invention is not limited to the disclosed examples. Other variations can be deducted by those skilled in the art without leaving the scope of protection of the claimed invention.

1. A computer-implemented method comprising:
detecting, by a processing unit, an event associated with an occupant of a building based on a request received from one or more sources;
obtaining, by the processing unit, occupant-context data associated with the occupant, from an identity graph of the occupant, upon detecting the event;
dynamically determining, by the processing unit, at least one action to be performed at one or more target devices in the building based on the occupant-context data, wherein the at least one action customizes functioning of the one or more target devices for the occupant; and
transmitting, by the processing unit, one or more instructions to the one or more target devices, for performing the at least one action determined.

2. The method of claim 1, wherein the identity graph of the occupant is generated based on personal data of the occupant received from the one or more sources, wherein the personal data comprises at least one of personally identifiable information and non-personally identifiable information.

3. The method of claim 2, wherein the identity graph is uniquely identified using a persistent identifier generated by hashing at least one personally identifiable information of the occupant.

4. The method of claim 1, wherein the occupant-context data comprises identifiers indicative of one or more of physiological data, demographic data, physiographic data, preferences, and a real-time location of the occupant.

5. The method of claim 1, wherein obtaining the occupant-context data associated with the occupant from the identity graph of the occupant, comprises:
authenticating a personally identifiable information of the occupant, obtained in relation to the event;
identifying the identity graph of the occupant from a database, based on a persistent identifier computed from the personally identifiable information; and
querying the identity graph of the occupant to retrieve the occupant-context data.

6. The method of claim 1, wherein dynamically determining, by the processing unit, the at least one action to be performed at the one or more target devices in the building based on the occupant-context data, comprises:
determining a customized configuration for the one or more target devices based on the occupant-context data; and
generating the one or more instructions for modifying a setting of the one or more target devices for effecting the customized configuration.

7. The method of claim 1, wherein the identity graph is dynamically updatable, by the processing unit, based on updated personal data of the occupant received from the one or more sources in real-time.

8. The method of claim 7, wherein dynamically updating the identity graph, by the processing unit, based on the updated personal data of the occupant comprises:
identifying a class of the updated personal data based on the source;
determining whether at least one node of the identity graph corresponds to the class of the updated personal data;
if at least one node of the identity graph corresponds to the class of the updated personal data, updating the node based on the updated personal data; and
if no node of the identity graph corresponds to the class of the updated personal data, creating a new node based on the updated personal data.

9. A context-aware building automation system comprising:
one or more sources configured to supply personal data associated with an occupant of a building;
one or more target devices; and
an apparatus communicatively coupled to the one or more sources and the one or more target devices, wherein the apparatus is configured to:
detect an event associated with an occupant of a building based on a request received from the one or more sources;
obtain occupant-context data associated with the occupant, from an identity graph of the occupant, upon detecting the event;
use the occupant-context data to dynamically determine at least one action to be performed at one or more target devices in the building, wherein the at least one action customizes functioning of the one or more target devices for the occupant; and
transmit one or more instructions to the one or more target devices, for performing the at least one action determined.

10. The building automation system of claim 9, wherein the apparatus generates the identity graph of the occupant based on the personal data of the occupant received from the one or more sources, wherein the personal data comprises at least one of personally identifiable information and non-personally identifiable information.

11. The building automation system of claim 10, wherein the identity graph is uniquely identified using a persistent identifier generated by hashing at least one personally identifiable information of the occupant.

12. The building automation system of claim 9, wherein the occupant-context data comprises identifiers indicative of one or more of physiological data, demographic data, physiographic data, preferences, physical attributes and real-time location of the occupant.

13. The building automation system of claim 9, wherein the apparatus obtains the occupant-context data associated with the occupant from the identity graph of the occupant by:
authenticating a personally identifiable information of the occupant, obtained in relation to the event;
identifying the identity graph of the occupant from a database, based on a persistent identifier computed from the personally identifiable information; and
querying the identity graph of the occupant to retrieve the occupant-context data.

14. The building automation system of claim 9, wherein the apparatus dynamically determines the at least one action to be performed at the one or more target devices in the building using the occupant-context data by:
determining a customized configuration for the one or more target devices based on the occupant-context data;
generating the one or more instructions for modifying a setting of the one or more target devices for effecting the customized configuration.

15. The building automation system of claim 9, wherein the apparatus is configured to dynamically update the identity graph based on updated personal data of the occupant received from the one or more sources in real-time.

16. The building automation system of claim 15, wherein the apparatus dynamically updates the identity graph in real-time based on the updated personal data of the occupant by:
identifying a class of the updated personal data based on the source;
determining whether at least one node of the identity graph corresponds to the class of the updated personal data;
if at least one node of the identity graph corresponds to the class of the updated personal data, updating the node based on the updated personal data; and
if no node of the identity graph corresponds to the class of the updated personal data, creating a new node based on the updated personal data.

17. A computer-program product having machine-readable instructions stored therein, which when executed by one or more processing units, cause the processing units to perform a method according to claim 1.

18. A computer-readable medium comprising the computer program product according to claim 17.
